(19) United States
(12) Patent Application Publication
(10) Pub. No.: US 2006/0006556 A1
(43) Pub. Date: Jan. 12, 2006

(54) Gas supply device by gasifying burnable liquid

(76) Inventor: Hung Yang Chen, Taipei (TW)

Correspondence Address: PRO-TECTOR INTERNATIONAL SERVICES, 20775 NORADA CT., SARATOGA, CA, 95070, US

(21) Appl. No.: 11/168,080

(22) Filed: Jun. 27, 2005

(30) Foreign Application Priority Data
Jul. 8, 2004 (TW) 093120470

(51) Int. Cl. B01D 47/06

(52) U.S. Cl. 261/78.1

(57) ABSTRACT

A gas supply device by gasifying burnable liquid comprises a container having a space for filling burnable gas; at least one layer of flow guide plate being arranged in the space; each flow guide plate being arranged with a filter element; a gas generating unit arranged on a container for generating gas and then inputting the container; an input unit arranged on the container for inputting gas from the gas generating unit to the container; a gas divider connected to a tube of the input unit; the gas divider having output holes for generating bubbles; at least one output unit arranged on the container for outputting gas in the container; a pressure sensing unit arranged on the container for sensing pressure within the container; and a constant temperature control unit arranged on the container for sensing temperature within the container for heating at a predetermined timing.

### FIELD OF THE INVENTION

The present invention relates to gas supply, and particularly to a gas supply device by gasifying burnable liquid, which agitates and gasifies light oil or solvent oil. The gasified burnable gas is transferred to an external combustion device for providing required fuel used in the combustion device.

### BACKGROUND OF THE INVENTION

In one prior art gas supply device disclosed in Taiwan Patent No. 232366, an oil containing steel bottle has a gas outlet tube and an air inlet tube for inputting compressing air at a top thereof. A lower edge of the air inlet tube extends to a bottom of the steel bottle for guiding compressor air into the oil. Then the air is agitated with the oil. A pump serves for pumping compressed air into the steel bottle. The outlet tube has at least one air transferred rubber tube for guiding burnable gas to a combustor.

In above device, no interface active is used. Thereby after a time period, water is mixed in the air to be pumped into the steel bottle so as to mix with the oil in the bottle. The water remains in the bottle so as to affect the combustion. Thereby it is necessary to remove the water in the bottle.

Furthermore, larger size oil molecules and oil drops will drain out with the burnable gas so as to affect the combustion of the combustor. In cool whether, since no temperature control device, the air supply is insufficient so that the combustion can not be performed successfully.

### SUMMARY OF THE INVENTION

Accordingly, the primary object of the present invention is to provide a gas supply device by gasifying burnable liquid which comprises a container having a space for filling burnable gas; at least one layer of flow guide plate being arranged in the space; each flow guide plate being arranged with a filter element; a gas generating unit arranged on a container for generating gas and then inputting the container; an input unit arranged on the container for inputting gas from the gas generating unit to the container; a gas divider connected to a tube of the input unit; the gas divider having output holes for generating bubbles; at least one output unit arranged on the container for outputting gas in the container; a pressure sensing unit arranged on the container for sensing pressure within the container; and a constant temperature control unit arranged on the container for sensing temperature within the container for heating at a predetermined timing.

The various objects and advantages of the present invention will be more readily understood from the following detailed description when read in conjunction with the appended drawing.

### BRIEF DESCRIPTION OF THE DRAWINGS

FIG. 1 is a schematic view of the gas supply device of the present invention.

FIG. 2 is a lateral schematic view of FIG. 1.

FIG. 3 is a schematic view showing the gas supply device of the present invention.

FIG. 4 is a schematic view showing the connection of the gas supply device and the combustion device according to the present invention.

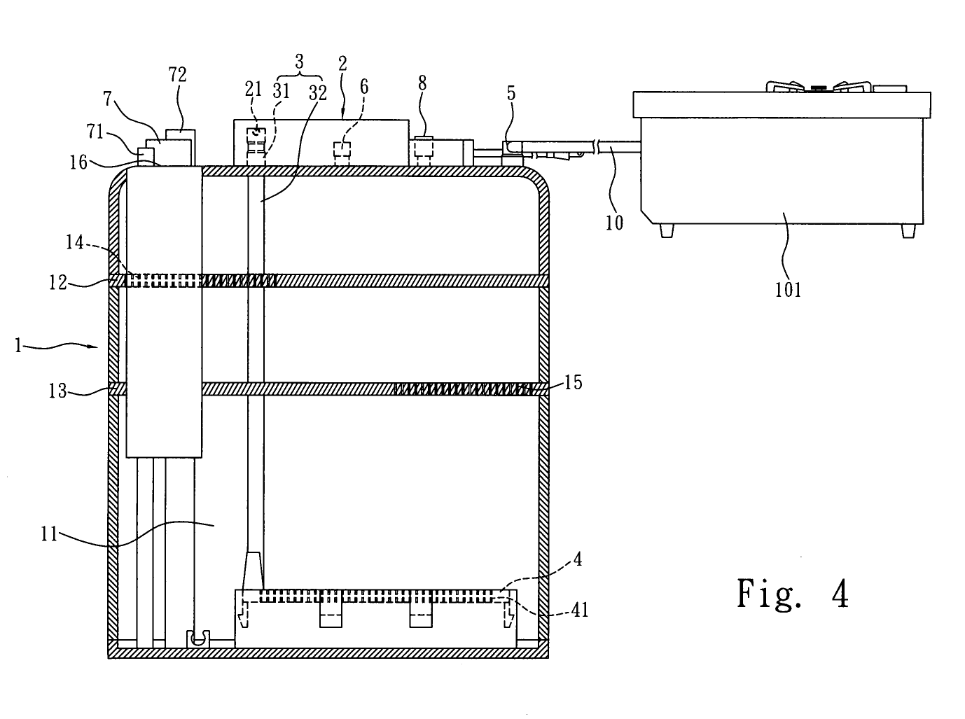

FIG. 5 is a schematic view showing another embodiment of the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

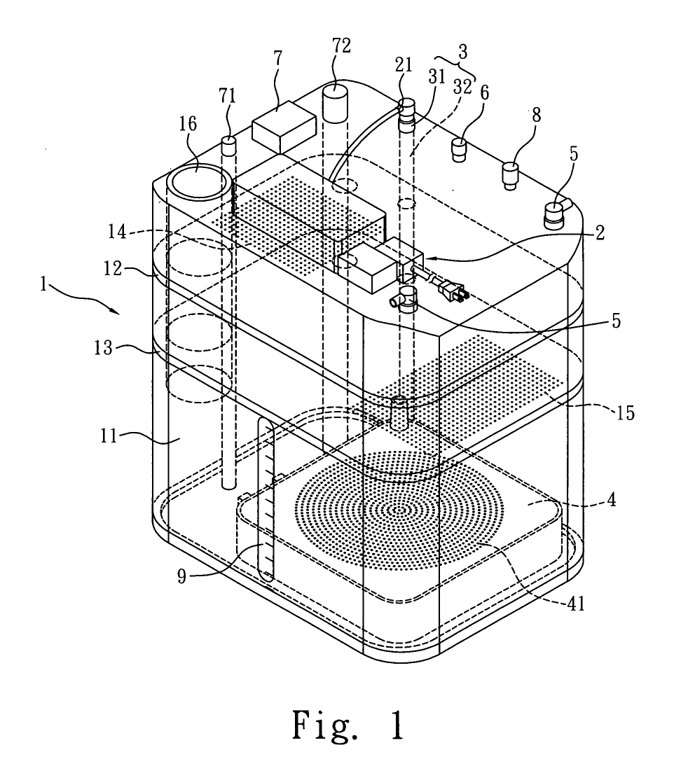

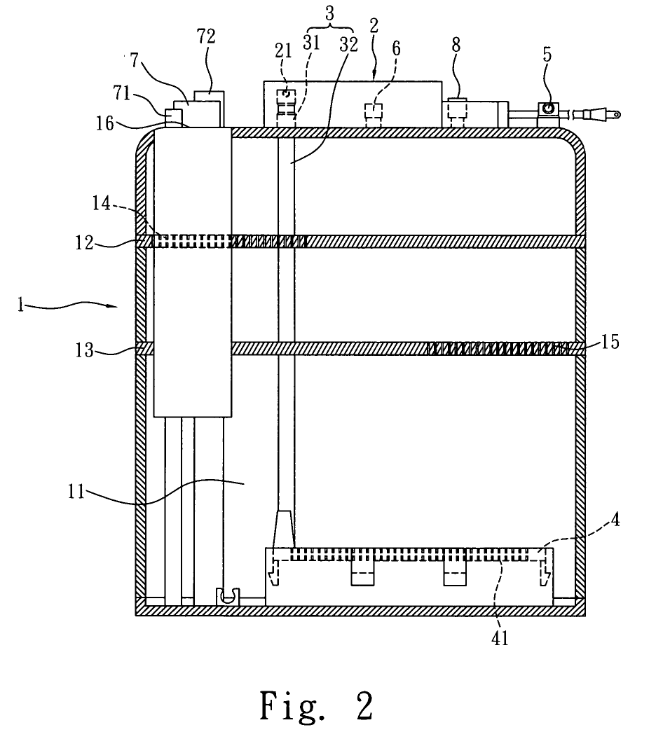

With reference to FIGS. 1, and 2, the structure of the present invention is illustrated. The present invention includes a container 1, a gas generating unit 2, an input unit 3, a gas divider 4, an output unit 5, a pressure sensing unit 6, a constant temperature control unit 7, a pressure releasing unit 8, and a detector 9. The container 1 serves to contain burnable liquid. Input gas serves to be agitated with burnable liquid to generate burnable gas for being outputted to an external combustion device.

The container 1 has a space 11 for filling burnable gas. At least one layer of flow guide plate 12, 13 are arranged in the space. Each flow guide plate 12, 13 is arranged with a filter element 14, 15. The filter element 14, 15 may be a net for filtering impurity of the gas or larger oil gas or oil drop. Moreover, the flow guide plates 12, 13 and filter elements 14, 15 serve to prevent burnable liquid from outputting with agitated burnable liquid (oil) in the gasifying process. Besides, the container 1 has an inlet 16 from filling burnable liquid.

The gas generating unit 2 is formed by a pump and a power source (for example, a transformer or a battery). The gas generating unit 2 can be arranged on a container 1 or is an external device to be connected to the container 1 for generating gas.

The input unit 3 is arranged on the container 1. The input unit 3 has a check valve switch 31 connected to an output end 21 of the gas generating unit 2 and a tube 32. The check valve switch 31 serves for preventing input gas from returning back so that the burnable oil flows back. Thereby, the gas supply device can operate successfully.

The gas divider 4 has a disk like shape and is connected to the tube 32. The gas divider 4 has output holes 41 which are arranged as a matrix. The output gas from the tube 32 flows into the gas divider 4 and then is outputted from the output holes 41 for dispersing the gas. Thereby, the gas is effectively mixed or agitated with the burnable liquid.

At least one output unit 5 is arranged on the container 1 for outputting gas in the container 1.

The pressure sensing unit 6 is arranged on the container 1. The pressure sensing unit 6 is an electronic type or an mechanic type for sensing pressure in the container 1. When the gas from the gas generating unit 2 generates gas which is then inputted to the container 1 to agitate with the burnable liquid. If the pressure sensing unit 6 senses that the internal pressure of the container 1 is sufficient, signals are outputted so that external control circuits stops the operation of the gas generating unit 2. If the pressure sensing unit 6 is insufficient, signals are outputted to make the external control circuit actuate the gas generating unit 2 for inputting gas to the container 1.

The constant temperature control unit 7 is arranged on the container 1. The constant temperature control unit 7 contains a temperature sensing element 71 and a heating element 72 for sensing temperature within the container 1 for heating at a predetermined timing. Thereby, the temperature of the container 1 is achieved to a state to gasify. Thereby, it can suit the variations of elevation or weather.

The pressure releasing unit 8 is made of a pressure releasing valve so as to be arranged on the container 1. When the gas supply device is not used, if the internal pressure of the container 1 is increased due to environmental factors, a part of pressure of the container 1 will be released by the pressure relief valve so as to retain a constant pressure of the container 1.

The detector 9 is a window which is arranged on the container 1. The amount of the burnable liquid in the container 1 is visible for being filled to the container 1.

By above structure, the present invention can be assembled.

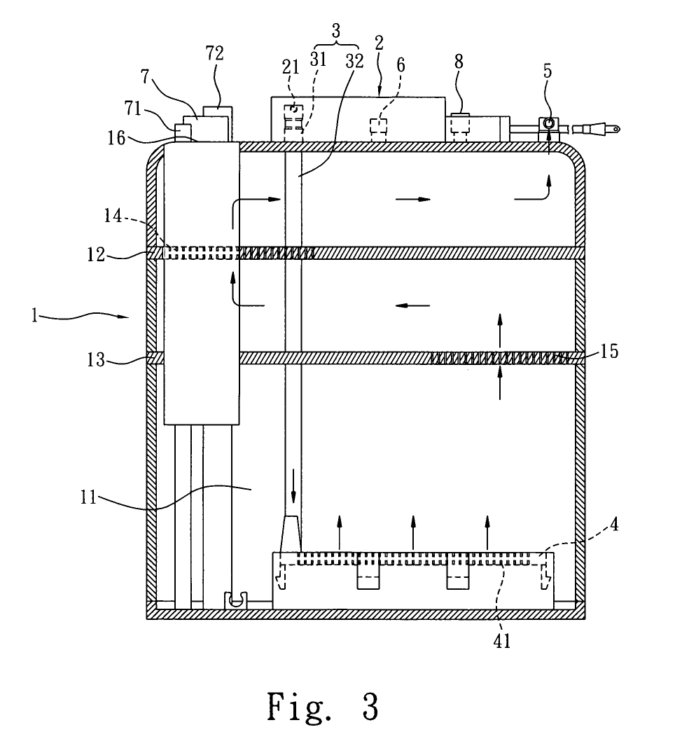

With reference to FIG. 3, a schematic view of the present invention is illustrated. As illustrated in the drawing, the burnable liquid, such as light oil or solvent is added to the container 1. Then the gas generating unit 2 is actuated for generating gas. Then gas flows through the check valve switch 31 of the input unit 3 and the tube 32 and then to the container 1. The check valve switch 3 1 serves to prevent the gas flow back so that the burnable oil flows back. Thereby, the gas can be provided successfully. When the gas is transferred to the gas divider 4, the gas will be dispersed uniformly to the plurality of output holes 41 to generate small bubbles. The bubbles are agitated with the burnable liquid for gasifying. The burnable liquid is gasified completely. After gasifying, the burnable liquid flows through the filter element 14 of the flow guide plate 12, the filter element 15 of the flow guide plate 13 and then to the output unit 5. Then, it is outputted by the output unit 5. Then it is further outputted by an output tube 10 connected to the output unit 5 to the combustion device 101. In the gasifying process of the burnable liquid, the flow guide plates 12, 13 and the filter elements 14, 15 serve to prevent larger oil moleculars and oil drops to spout out.

The pressure sensing unit 6 sense an internal pressure of the container 1. In use, when the pressure sensing unit 6 feels that the internal pressure of the container 1 is insufficient. A control signal is outputted to a control circuit to actuate the gas generating unit 2 to operate. When the pressure sensing unit 6 senses that the internal pressure of the container 1 is insufficient, a control signal is outputted to stop the operation of the gas generating unit 2.

When the external combustion device 101 combusts, gas will be drew out. The oil temperature in the device for supplying gasified burnable liquid will descend. After the sensing element 71 of the constant temperature control unit 7 senses the state, a signal is outputted to the heating unit 72 through the control circuit for heating so that temperature of the oil will achieve a predetermined value.

When the device for supplying gasified burnable liquid is not used, if the internal pressure of the container 1 increases, the pressure relies unit will adjust to release pressure.

Further, the container 1 can be formed by plastic or metal molding. The detector 9 has a window on the container 1 for detecting the liquid amount in the container 1.

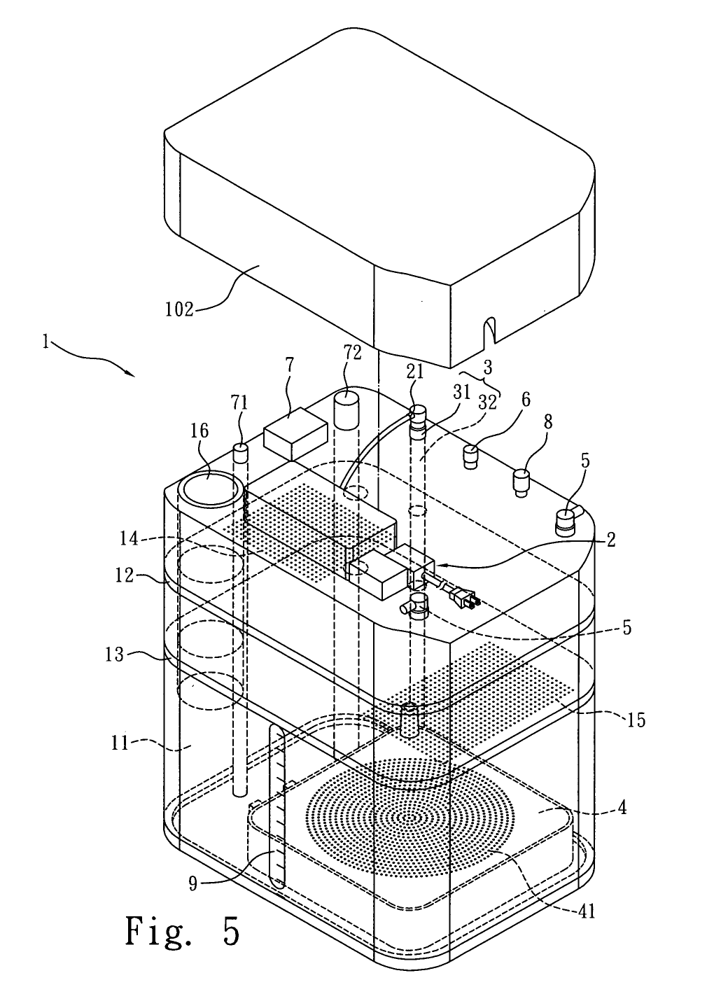

Moreover, a cover 102, see FIG. 5, can be arranged on the container 1 for assuring every unit of the container 1 will not be destroyed by external objects.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A gas supply device by gasifying burnable liquid comprising:
a container having a space for filling burnable gas; at least one layer of flow guide plate being arranged in the space; each flow guide plate being arranged with a filter element;
a gas generating unit arranged on a container for generating gas and then inputting the container;
an input unit arranged on the container for inputting gas from the gas generating unit to the container;
a gas divider connected to a tube of the input unit; the gas divider having output holes for generating bubbles;
at least one output unit arranged on the container for outputting gas in the container;
a pressure sensing unit arranged on the container for sensing pressure within the container; and
a constant temperature control unit arranged on the container for sensing temperature within the container;
wherein the gas generating unit generates gas, the gas is inputted into the container; the gas is uniformly distributed by the gas divider and then bubbles are outputted through the at least one output unit.

2. The gas supply device by gasifying burnable liquid as claimed in claim 1, wherein the container is made by integrally molding of plastics or metal.

3. The gas supply device by gasifying burnable liquid as claimed in claim 1, wherein the filtering elements are nets.

4. The gas supply device by gasifying burnable liquid as claimed in claim 1, wherein the container has an inlet for filling burnable liquid.

5. The gas supply device by gasifying burnable liquid as claimed in claim 1, wherein the gas generating unit is formed by a pump and a power source.

6. The gas supply device by gasifying burnable liquid as claimed in claim 5, wherein the power source is selected from one of a transformer and a battery.

7. The gas supply device by gasifying burnable liquid as claimed in claim 1, wherein the gas generating unit is an external device.

8. The gas supply device by gasifying burnable liquid as claimed in claim 1, wherein the input unit is formed by a check valve switch and a tube which is connected to the check valve switch and inserted into the container.

9. The gas supply device by gasifying burnable liquid as claimed in claim 1, wherein the gas divider has a disk like box.

10. The gas supply device by gasifying burnable liquid as claimed in claim 1, wherein the pressure sensing unit is an electric or a mechanic device.

11. The gas supply device by gasifying burnable liquid as claimed in claim 1, wherein the constant temperature control unit contain a temperature sensing element and a heating element.

12. The gas supply device by gasifying burnable liquid as claimed in claim 1, wherein the container has a pressure relief unit.

13. The gas supply device by gasifying burnable liquid as claimed in claim 12, wherein the pressure relief unit is formed by a pressure relief valve.

14. The gas supply device by gasifying burnable liquid as claimed in claim 1, wherein the container is installed with a detecting unit.

15. The gas supply device by gasifying burnable liquid as claimed in claim 14, wherein the detecting unit has a window installed on the container.

16. The gas supply device by gasifying burnable liquid as claimed in claim 1, wherein the container has a cover for protecting parts in the container.
